(19) United States
(12) Patent Application Publication
(10) Pub. No.: US 2015/0266541 A1
(43) Pub. Date: Sep. 24, 2015

(54) CRANK ARM FOR A BICYCLE PEDAL CRANK SYSTEM AND A METHOD FOR ITS PRODUCTION

(71) Applicant: Holger Faupel, Herzberg am Harz (DE)

(72) Inventor: Holger Faupel, Herzberg am Harz (DE)

(21) Appl. No.: 14/661,022

(22) Filed: Mar. 18, 2015

(30) Foreign Application Priority Data
Mar. 18, 2014 (DE) 10 2014 103 701.4

(51) Int. Cl. B62M 3/00; B29C 45/14; B29D 22/00; B29C 45/00

(52) U.S. Cl. CPC B62M 3/00; B29C 45/0005; B29C 45/14819; B29D 22/00; B29K 2077/10

(57) ABSTRACT

A crank arm for a bicycle crank arm system has an elongated hollow core (30) made of a first fiber-reinforced plastic and having, in the final assembly position of the pedal crank system, a laterally located, exterior front face, a rear face opposed thereto and two side faces (102) that connect the front face and rear face with one another, and having at its axial ends (104, 105) metallic shaft sleeves (20, 22), oriented parallel to one another and to the side faces (102), for accommodating a bottom bracket shaft or a pedal axle. The hollow core (30) is encased by a second fiber-reinforced plastic. A carbon fiber thread (50) is wrapped multiple times axially around the hollow core (30) and is in contact with the axially convex side surfaces. The hollow core (30) is bonded to the carbon fiber thread (50).

### BACKGROUND

1. Field of the Invention

The invention relates to a crank arm for a bicycle pedal crank system, comprising an elongated hollow core made of a first fiber-reinforced plastic, and having, in the final assembly position of the pedal crank system, a laterally located, exterior front face, a rear face opposed thereto, and two side faces that connect the front face and rear face with one another, and having at its axial ends metallic shaft sleeves oriented parallel to one another and parallel to the side faces, for the purpose of accommodating a bottom bracket shaft or a pedal axle, wherein the hollow core is encased by a second fiber-reinforced plastic. The invention further relates to a production method for producing such a crank arm.

2. Description of the Related Art

Crank arms and methods for their production are known from DE 602 22 348 T2.

As is known, pedal crank systems for bicycles comprise a bottom bracket installed at a central position on the bicycle frame, with cranks attached to its bottom bracket shaft on both sides. Each crank comprises a crank arm that is non-rotationally attached at one axial end to the bearing shaft by means of a shaft sleeve, and that has at its other axial end a further shaft sleeve for attaching a pedal axle in a non-rotational manner The crank on the drive side usually also has a so-called crank spider that serves as a carrier for one or more chain rings. Variants are known in which the drive-side crank arm is designed as a single piece with the crank spider; however variants are also known in which the crank arm and crank spider are separately formed.

The pedal crank system is the principal interface with the rider and as such, is exposed to considerable mechanical stresses, and it must therefore be designed to be sufficiently robust. This applies in particular to the crank arms, which act as levers. On the other hand, especially in competitive cycling, there is a demand for all components to be as light as possible, i.e. including the pedal crank system and especially the crank arms. This presents a fundamental conflict of interest, which manufacturers attempt to solve through various approaches.

The aforementioned, generic publication discloses using a tubular element made of a fiber-reinforced plastic matrix as a hollow core of a crank arm. The two shaft sleeves are arranged at both axial ends of this hollow core, the shaft sleeves being attached to the hollow core by a positive-locked insertion mechanism. The hollow core prepared in this manner is then inserted, along with a mixture of aligned carbon fibers and a thermosetting plastic, into a mold cavity consisting of two half molds. The two half molds are pressed together under pressure and heat so that the still plastic thermosetting material flows around the hollow core, and then is hardened under pressure at a predetermined setting temperature. Although the publication mentioned also discloses the use of non-aligned carbon fibers, experience teaches that such approaches do not result in the desired levels of robustness in the context of the known method. The process therefore requires significant manual work and as such, is expensive.

DE 602 09 962 T2 discloses a further method to produce a crank arm having a hollow core, which, however, requires even more manual work. In this case, the crank arm is prepared by wrapping a carbon fiber fabric in a spiral pattern around a solid body, together with its attachment parts, in particular the shaft sleeves, with the fabric being wrapped substantially perpendicular to the longitudinal extension of the body. Next, additional shell-like layers of carbon fiber fabric are applied and soaked with suitable resins. Then the entire workpiece is hardened under pressure and heat, whereby the solid body which may be made, for example, of sand and non-heat-resistant synthetic resin, breaks down and can trickle out through a hole provided specially for this purpose.

EP 1 486 413 A2 discloses crank arms manufactured in a manner in which continuous carbon fibers are wrapped in loops around the two shaft sleeves and then inserted, along with a mixture of aligned carbon fibers and a thermosetting plastic, into a hollow mold composed of two half molds. In other words, this is basically the method known from DE 602 09 962 T2, which is described above, except a looser, multi-layered loop made of long carbon fibers is used instead of the tubular hollow core. These methods are very expensive due to the high amount of labor required. Cheaper methods that can be automated, especially those which rely on the injection molding technique, have so far not been able to establish themselves because the attainable strength values are insufficient.

DE 100 60 042 A1 discloses a metal-plastic composite component whose production first requires a metallic section with long carbon fibers embedded in its metal with significant overhang. In particular, the carbon fibers extend beyond the metal surface which, in the finished composite component, is intended to contact a section made of plastic. Said metal section is then inserted into a hollow mold into which a thermosetting plastic is injected and hardened in order to form the plastic section, wherein the overhanging parts of the fibers are embedded in the plastic. Although this improves the coupling of the different material sections, it does not improve the tensile strength of each individual material section.

Finally, DE 697 16 396 T2 discloses a stabilization plate which has been directly overmolded with a fiber-reinforced plastic material in order to create a load-bearing torsion bar

The object of the present invention is to provide a cheaper method to produce crank arms and corresponding crank arms of high strength and low weight.

### SUMMARY OF THE INVENTION

This problem is solved in that a carbon fiber thread is wrapped multiple times in an axial direction around the hollow core. The thread is in contact with the axially convex side surfaces, and the hollow core is bonded to said thread.

The corresponding production method comprises providing an elongated, closed hollow core from a first fiber-reinforced plastic with a matrix consisting of a first thermoplastic material, wherein the hollow core has a front face, a rear face opposed thereto and two axially convex side faces which connect the front and rear faces, said core having at its axial ends metallic shaft sleeves oriented parallel to one another and also to the side faces in order to accommodate a bottom bracket shaft or a pedal axle. The method then includes wrapping a carbon fiber thread encased in a thermoplastic material multiple times axially around the hollow core and inserting the wrapped hollow core into a plastic injection molding tool. The method proceeds by overmolding the wrapped hollow core inside the plastic injection molding tool with a fiber-filled, second thermoplastic material, with the temperature of the second thermoplastic material and/or of the plastic injection molding tool being adjusted so that during overmolding, the surface of the hollow core and that of the encasing thermoplastic material is fused or melted on, thus resulting in a bonded connection.

The approach according to the invention of wrapping a stabilizing carbon fiber thread around the hollow core in the axial direction allows cheaper injection molded bodies to be used as the hollow core. The necessary flexural rigidity can easily be implemented in such injection molding bodies by means of suitable rib structures, such as in the form of a so-called “Nuremberg grid” [“Nürnberger Gitter”]. The flexural rigidity of the crank arm therefore essentially results from the structural stability of its hollow core. However, the low axial rigidity of injection molded bodies, including those made of plastics filled with non-ordered fibers, has been problematic in the past. This axial rigidity is required in particular at the bottom dead center of the crank's [rotational] movement. Closely wrapping around the hollow core a carbon fiber thread that is extremely strong in the longitudinal direction serves to counteract the elongation of the plastic of the hollow core in an axial direction. Flexural forces acting on the crank arm are therefore substantially absorbed by the reinforcing structure of the plastic hollow core, while axial forces are absorbed by the tensile strength of the carbon fiber thread.

To ensure that the carbon fiber thread is wrapped closely all around the surface of the hollow core, the side faces of the latter are axially convex. The axial ends of the hollow core are also preferably rounded (beyond the shaft sleeves) and are formed with radii that merge continuously with the convexity of the side faces. When the hollow core is shaped in this manner, the carbon fiber thread can therefore be in contact with the external surface of the hollow core over its entire length.

Maximizing the contact area between the carbon fiber thread and the hollow body is especially advantageous with regard to the bonded connection between the carbon fiber thread and the hollow core according to the invention.

As mentioned, it is especially preferred that the first fiber-reinforced plastic, i.e. the plastic from which the hollow core is made, has a thermoplastic matrix. With regard to the production method pursuant to the invention, this means that a thermoplastic material with suitable fiber filling is used as the starting material for the first fiber-reinforced plastic. In particular, reinforcement with long carbon fibers has been found to be advantageous here. In the present case, long fibers are to be understood as having a length of 5 to 7 mm. A filling volume of 30 to 40% has been found to be advantageous for the first fiber-reinforced plastic. Aromatic polyamides are regarded as especially advantageous as matrix material.

With regard to the creation of the bonded connection between the carbon fiber thread and hollow core, an especially advantageous further development of the invention suggests using a carbon fiber thread that is encased in thermoplastic material. In the past, forming a solid connection between carbon fibers and a thermoplastic material has proven very difficult. Recently, however, “endless” carbon fiber threads encased in a thermoplastic material have become commercially available. For example, the company EMS-Grivory has just begun to offer a product called “LFT tapes” [long-fiber reinforced thermoplastics]. These are endless carbon fiber threads whose surface has been subjected to appropriate chemical and/or mechanical pretreatment, so that they form a firm bonded connection with an encasing thermoplastic material. Wrapping such a thermoplastic-encased carbon fiber thread around the hollow core pursuant to the invention makes it possible to create a bonded connection between the carbon fiber thread and the hollow core in an especially easy manner. All that is required to create the desired bonded connection is to fuse or melt the surface of the hollow core, on the one hand, and of the encasing thermoplastic, on the other. This can be done in a separate step or, in accordance with the production method as per the invention, during an overmolding step that also fundamentally serves to finish the surface.

In a preferred embodiment of the invention it is provided that the wrapped hollow core is encased in a second fiber-reinforced plastic having a thermoplastic matrix. This encasing is preferably accomplished by overmolding the wrapped hollow core, which has been laid inside a plastic injection molding tool, with a fiber-filled, second thermoplastic material. If the temperature of the second thermoplastic material and/or of the plastic injection molding tool is suitably set during this overmolding step, the surface of the hollow core and of the encasing thermoplastic material can be fused or melted during overmolding so as to produce the desired bonded connection—namely, on the one hand, between the encasing thermoplastic material and the thermoplastic material of the hollow core, i.e. effectively between the hollow core and the carbon fiber thread, and secondly, between the encasing thermoplastic material and the second thermoplastic material, i.e. effectively between the carbon fiber thread and the second thermoplastic material, and thirdly, between the first and second thermoplastic materials. If the first, second and encasing thermoplastic materials are identical, a uniform material connection results.

The thermoplastic materials used, however, may differ from one another. In a preferred further development of the invention it is provided, in particular, that the second fiber-reinforced plastic has a thermoplastic elastomer matrix. With regard to the production method according to the invention, this means that the second thermoplastic material is a thermoplastic elastomer. This variant is especially advantageous with regard to mountain biking (MTB) and cyclocross products, in which the crank arms can be expected to receive strong impacts from stones or branches. In this case, the elastomer coating provides effective protection for the underlying notch-sensitive carbon fiber thread structure. Alternatively, other thermoplastic materials can be used instead of a thermoplastic elastomer. Polyamide 12 in particular has been found to be especially advantageous.

Using short reinforcement fibers, i.e. reinforcement fibers with a length of 1 to 2 mm, as the filling for the second thermoplastic material has been found to be advantageous. This produces very smooth surfaces. A filling volume of 30 to 40% is regarded as advantageous in this case as well. Again, carbon fibers in particular are considered suitable for use as the reinforcement fibers. Mineral filling materials, such as glass or talcum, can be also used especially when selecting a thermoplastic elastomer as the second thermoplastic material.

The invention can be refined still further with regard to the detailed procedural steps. For example, the process of wrapping the hollow core can be automated and standardized very easily by welding one end of the encased carbon fiber thread to the hollow core in order to wrap the latter. Wrapping can then proceed by rotating the hollow core while maintaining a predetermined tension on the carbon fiber thread. After the hollow core has been wrapped with the encased carbon fiber thread, the other end of the latter is preferably welded to the hollow core. Further handling of the hollow core is then completely unproblematical. In particular, there is no longer a risk of the carbon fiber thread accidentally detaching or slipping from the hollow core. The reliability of the connection can be augmented still further by spot welding the encased carbon fiber thread to the hollow core between its ends after it has been wrapped around the hollow core. In all cases, the welding is preferably done by means of ultrasonic welding.

As mentioned above, it is primarily the reinforcing structure of the hollow core that is responsible for the flexural rigidity of the crank arm. To produce a hollow core with a correspondingly complex shape using the preferred injection molding process, the hollow core is best formed in two parts, namely one consisting of a rib-reinforced trough-shaped element as well as possibly a similarly rib-reinforced cover element, which of course may also itself be trough-shaped. Before preparing the hollow core it is then manufactured by welding the aforementioned elements together.

It is preferable that the shaft sleeves also be fixed in place simultaneously during the process of producing the rib-reinforced trough element. In an advantageous embodiment of the invention, during the process of producing the hollow core from the fiber-filled first thermoplastic material using the injection molding process, the shaft sleeves are overmolded with this first thermoplastic material. In other words, metal inserts which then form the shaft sleeves are used during the molding of the rib-reinforced trough element. The necessary rotational and translational rigidity of the shaft sleeves can be simply ensured by giving the inserts a suitable non-symmetrical shape.

Additional features and advantages of the invention are evident from the following special description and the drawings.

### BRIEF DESCRIPTION OF THE DRAWINGS

FIG. 1 is a top view of a rib-reinforced trough element used to form a hollow core.

FIG. 2 is a cover to weld to the trough from FIG. 1 in order to form the hollow core.

FIG. 3 is a top view of a hollow core formed from the elements from FIG. 1 and FIG. 2.

FIG. 4 is a cross section through a hollow core along the line IV-IV in FIG. 3.

FIG. 5 is a hollow core from FIG. 3 during the wrapping process.

FIG. 6 is a top view of the hollow core wrapped as per FIG. 5.

FIG. 7 is a lateral view of the wrapped hollow core from FIG. 6.

FIG. 8 is an eccentric view of an injection molding form with a wrapped hollow core laid inside, for execution of the molding step.

FIG. 9 is a top view of the crank arm resulting from the overmolding step shown in FIG. 8.

FIG. 10 is a cross section of the crank arm from FIG. 9 along a line analogous to the line X-X in FIG. 8.

### DETAILED DESCRIPTION OF THE PREFERRED EMBODIMENTS

Identical reference numbers in the figures refer to identical or analogous elements.

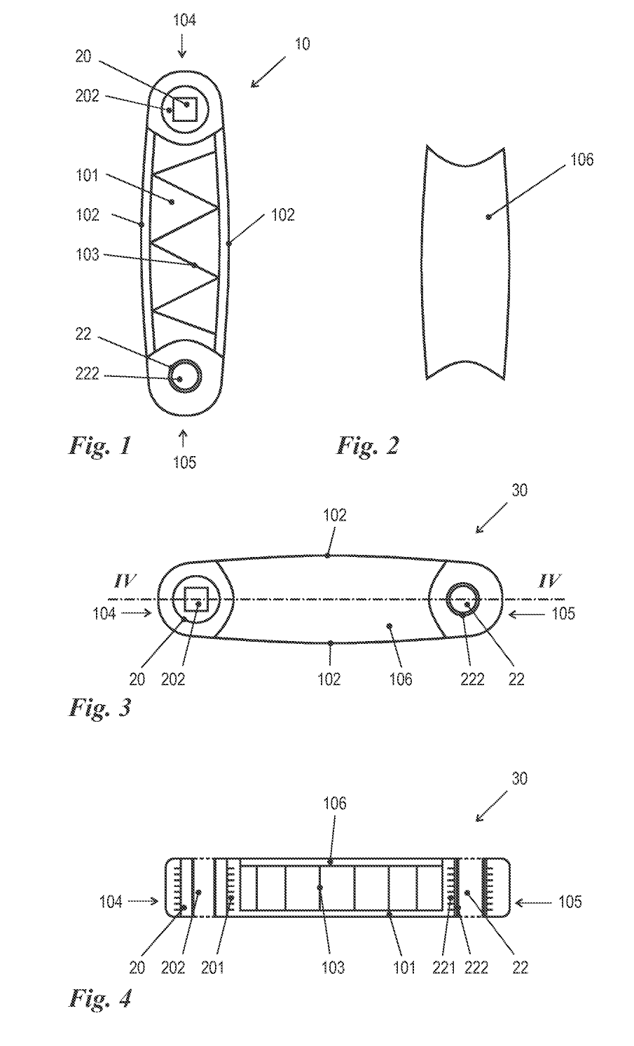

An advantageous embodiment of the production method according to the invention is described below, with reference to FIGS. 1 to 10, from which the characteristics of an advantageous embodiment of the crank arm according to the invention are also at least implicitly evident.

FIG. 1 shows a rib-reinforced trough-shaped element 10 that has been produced using a plastic injection molding method step. The trough 10 has an elongated extension and is basically formed from a floor 101 and side walls 102 oriented perpendicular to it. The floor 101 and the side walls 102 form a cavity in which is arranged, in a purely schematic manner, a rib structure 103 which in practice can be designed as a Nuremberg grid [Nürnberger Gitter], for example. The rib structure 103 is preferably produced during the same plastic injection molding step as the floor 101 and side walls 102.

At its axial ends 104, 105, the trough 10 has non-hollow areas into which the shaft sleeves 20, 22 are injected. The shaft sleeves 20, 22 are preferably laid in the injection molding form for the trough 10 as inserts and are overmolded with the plastic material of which the trough 10 is made during the plastic injection molding step. As is evident in the cross section shown in FIG. 4, in particular, the shaft sleeves 20, 22 preferably possess lateral, fin-like projections 201, 221 that are preferably designed to be non-rotationally symmetrical. When these projections 201, 221 are overmolded, the shaft sleeves 20, 22 are secured against rotation and translation.

The shaft sleeves 20, 22 in the embodiment shown have continuous channels 202, 222. The channel 202 of the upper shaft sleeve 20 in FIG. 1 has a square profile and, in the finished crank arm, serves to accommodate the square-shaped bearing shaft. The channel 222 of the lower shaft sleeve 22 in FIG. 1 has a round profile and has threads on its surface which allow the pedal axle to be screwed onto the finished crank arm.

The shaft sleeves are preferably made of a light metal, especially aluminum. The trough material is preferably a long-fiber-reinforced thermoplastic material, and especially preferably, is a long-carbon fiber-reinforced aromatic polyamide.

FIG. 2 shows a cover 106 that is adapted to the shape of the opening of the trough 10 and that is preferably produced in a separate injection molding process from the same material as the trough 10.

FIG. 3 shows a hollow core 30 which results from a bonded connection, especially in the form of welding, of the lid 106 to the trough 10. The connection between the cover 106 and trough 10 must be sufficiently tightly sealed that it is not possible for any thermoplastic material to penetrate into the cavity of the trough 10 during a subsequent injection molding process. A top view of the hollow core 30 is shown in FIG. 3. FIG. 4 shows a cross section of the hollow core along line IV-IV in FIG. 3.

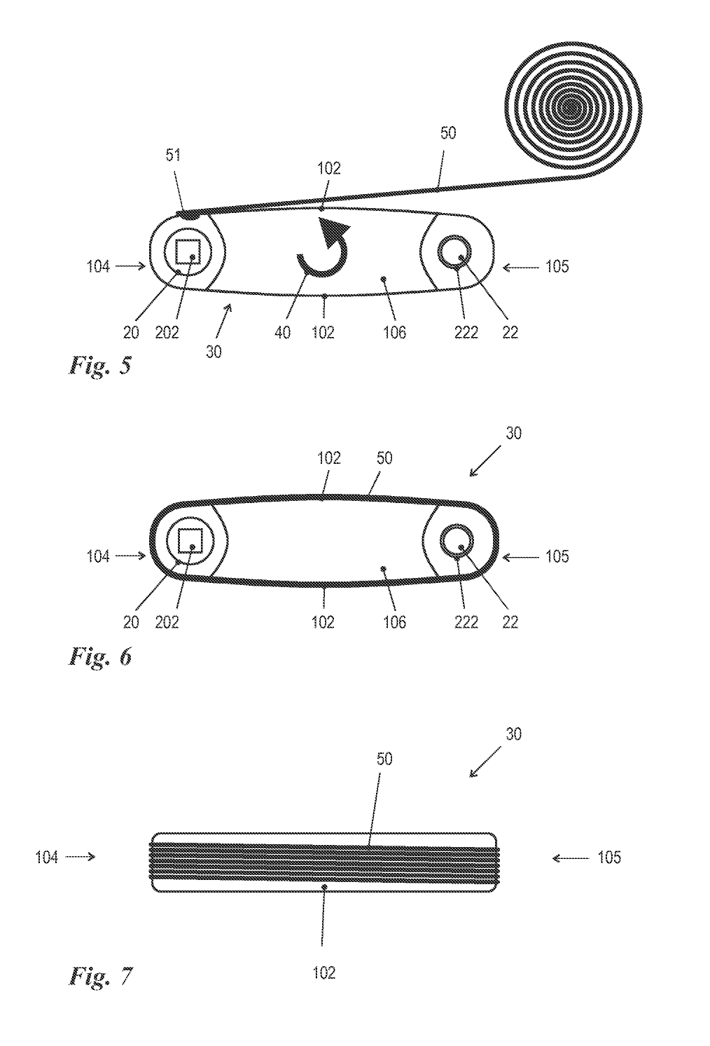

FIG. 5 shows a subsequent procedural step in which a carbon fiber thread 50 encased in a thermoplastic material is wrapped axially around the hollow core 30. At the start of the procedural step, the end 51 of the carbon fiber thread encased in a thermoplastic material is welded to the thermoplastic material of the hollow core 30. If the hollow core 30 is then rotated around an axis of rotation parallel to the channels 202, 222 of the shaft sleeves 20, 22, as indicated by the rotation arrow 40 in FIG. 5, and the carbon fiber thread 50 encased in a thermoplastic material is dispensed under a predetermined tension from a spool, the carbon fiber thread encased in a thermoplastic material will as a result be tightly and axially wrapped around the hollow core 30 in a defined manner.

The result of this process is shown in FIGS. 6 and 7, where FIG. 6 shows a top view and FIG. 7 shows a lateral view of the wrapped hollow core 30. This procedural step reveals the particular importance of the axially convex side faces 102 of the hollow core 30 and trough 10. Especially when, as in the exemplary embodiment shown, the axial ends 104, 105 of the hollow core 30 and of trough 10 are also rounded and are designed convexly to merge continuously with the convexity of the side walls 102, the carbon fiber thread 50 encased in a thermoplastic material is then completely and directly in contact with the exterior surface of the hollow core 30. The carbon fiber thread encased in a thermoplastic material thus forms a loop that counteracts any axial elongation of the hollow core 30 and of the finished crank arm, which is subject to axial stress between the shaft sleeves 20, 22.

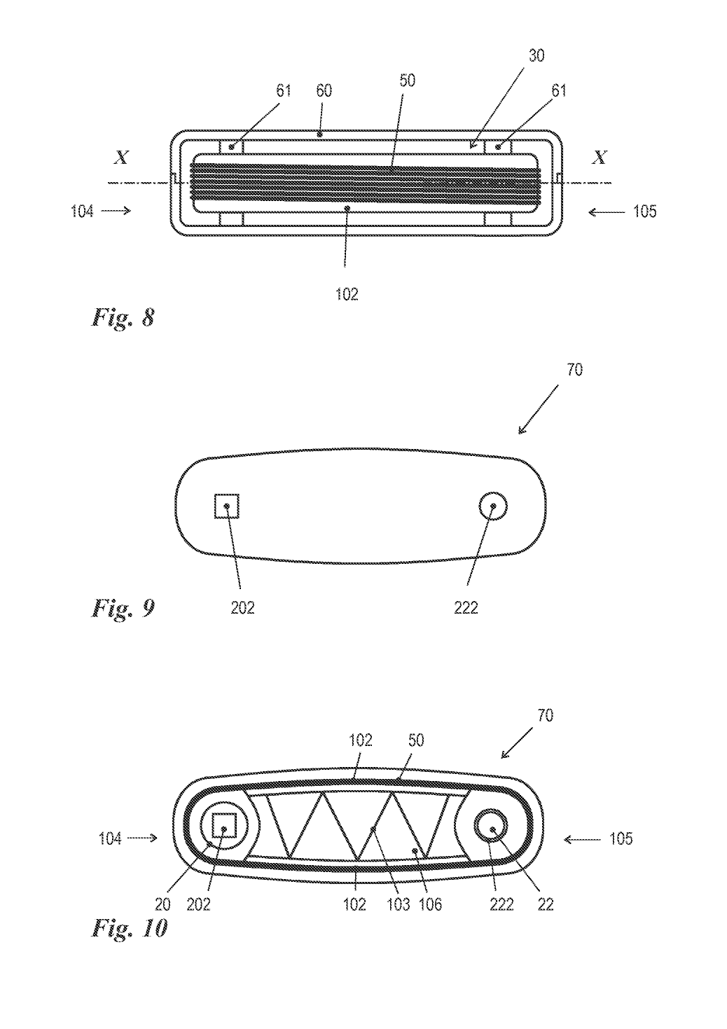

FIG. 8 shows a further procedural step in which the wrapped hollow core 30 is laid in an injection mold 60, which is preferably equipped with mandrels 61, which penetrate into the channels 202, 222 and seal them. Moreover, the hollow core 30 does not come into contact with any of the walls of the injection mold 60. It follows that when the injection mold 60 is filled with a thermoplastic material heated to a temperature greater than its melting temperature, the hollow core 30 is completely overmolded, while the channels 202, 222 however remain open and accessible from the exterior.

A top view of a resulting crank arm 70 is shown in FIG. 9. FIG. 10 shows a cross section through the crank arm from FIG. 9, whereby the section line is indicated in FIG. 8 as line X-X.

The overmolding material for the overmolding process shown in FIG. 8 is preferably a short-fiber-reinforced thermoplastic material, preferably a short-carbon-fiber-reinforced thermoplastic material. The short fiber length, compared to the fiber length of the reinforcement fibers used in the trough 10 and cover 106, results in a smoother surface and is therefore preferred for this step, which is only of subordinate importance for the strength of the crank arm 70. A thermoplastic elastomer, in particular, can be used as a plastic matrix.

A person skilled in the art is in principle largely unrestricted with regard to selecting the thermoplastic materials, i.e. the first thermoplastic material for the trough 10 and cover 106, the overmolding thermoplastic material and the encasing thermoplastic material for the carbon fiber threads 50, and can make his choice based on the requirements of the respective individual case. However, the three thermoplastic materials must be matched to each other to a certain extent. In particular, the melting points of the three thermoplastic materials should be coordinated so that during the overmolding process as per FIG. 8, the heat introduced by the overmolding thermoplastic material and, possibly, by the injection mold 60, and/or by any auxiliary heater, e.g. a radiant heater, is sufficient to fuse or melt the surfaces of both the encasing thermoplastic material as well as of the first thermoplastic material of the trough 10 so that a bonded connection results between the three thermoplastic materials, and therefore also with the carbon fiber thread. Of course, in light of this objective, a person skilled in the art must also take into account the chemical compatibility of the thermoplastic materials used. These are, however, common considerations for a person skilled in the art.

Naturally, the embodiments discussed in the special description and in the figures serve only as illustrative exemplary embodiments of the present invention. The present disclosure places a broad spectrum of possible variations at the disposal of a person skilled in the art. For instance, to support the bonded connection between the hollow core 30 and the carbon fiber thread encased in a thermoplastic material, it can be provided that the respective contact points can be preheated during the wrapping process immediately before being brought into contact and thereby fused or melted, e.g. by using a radiant heater or laser.

### LIST OF REFERENCE NUMBERS

10 Trough
101 Floor
102 Side wall
103 Rib structure
104 First axial end
105 Second axial end
106 Cover
20 First shaft sleeve
201 Projections
202 Channel in 20
22 Second shaft sleeve
221 Projections
222 Channel in 22
30 Hollow core
40 Rotation arrow
50 Carbon fiber thread
51 First end of 50
60 Injection mold
61 Mandrel
70 Crank arm

What is claimed is:

1. A crank arm for a bicycle pedal crank system, comprising an elongated hollow core (30) made of a first fiber-reinforced plastic and having, in a final assembly position of the pedal crank system, a laterally located, exterior front face, a rear face opposed to the front face and two side faces (102) that connect the front face and rear face with one another, the arm having at its axial ends (104, 105) metallic shaft sleeves (20, 22), oriented parallel to one another and to the side faces (102) for accommodating a bottom bracket shaft or a pedal axle, the hollow core (30) is encased by a second fiber-reinforced plastic and a carbon fiber thread, wrapped multiple times in the axial direction around the hollow core (30), said thread (50) being in contact with the axially convex side surfaces , and said hollow core (30) being bonded to said thread (50).

2. The crank arm of claim 1, wherein the first fiber-reinforced plastic has a thermoplastic matrix.

3. The crank arm of claim 1, wherein the carbon fiber thread (50) is bonded to the second fiber-reinforced plastic.

4. The crank arm of claim 1, wherein the second fiber-reinforced plastic has a thermoplastic matrix.

5. The crank arm of claim 4, wherein the second fiber-reinforced plastic has a thermoplastic elastomer matrix.

6. A method for producing a crank arm for a bicycle pedal crank system, comprising the following steps:
providing of an elongated, closed hollow core (30) made of a first fiber-reinforced plastic with a matrix made of a first thermoplastic material, wherein the hollow core (30) has a front face, a rear face opposed thereto and two axially convex side faces (102) which connect the front face and rear face with one another, said hollow core (30) having metallic shaft sleeves (20, 22) at its axial ends (104, 405), said shaft sleeves (20, 22) being oriented parallel to one another and to the side faces, for accommodating a bottom bracket shaft or a pedal axle;
wrapping multiple times axially around the hollow core (30) a carbon fiber thread (50) that is encased in a thermoplastic material;
inserting the wrapped hollow core (30) into a plastic injection molding tool (60); and
overmolding the wrapped hollow core (30) in the plastic injection molding tool (60) with a fiber-filled, second thermoplastic material, wherein the temperature of the second thermoplastic material and/or of the plastic injection molding tool is set so that the surface of the hollow core (30) and of the encasing thermoplastic material fuses or melts during overmolding so that a bonded connection results.

7. The method of claim 6, wherein the axial ends (104, 105) of the hollow core (30) have a round shape with radii that merge continuously with the convexity of the side faces (102).

8. The method of claim 6, wherein a first end (51) of the encased carbon fiber thread (50) is welded to the hollow core (30) in order to wrap the hollow core (30) with the encased carbon-fiber thread (50).

9. The method of claim 8, wherein a second end of the encased carbon fiber thread (50) is welded to the hollow core (30) after the hollow core (30) has been wrapped with the encased carbon fiber thread (50).

10. The method of claim 9, wherein the encased carbon fiber thread (50) is spot welded between its ends to the hollow core (30) after the hollow core (30) has been wrapped with the encased carbon fiber thread (5).

11. The method of claim 10, wherein the encased carbon fiber thread (50) is welded to the hollow core (30) by ultrasonic welding.

12. The method of claim 6, wherein the hollow core (30) is produced by welding a cover element (106) to a rib-reinforced trough (10).

13. The method of claim 12, the rib-reinforced trough (10) is produced from the fiber-filled, first thermoplastic material using the plastic injection molding process, wherein the shaft sleeves (20, 22) are overmolded with the fiber-filled, first thermoplastic material.

14. The method of claim 6, wherein the second thermoplastic material is a thermoplastic elastomer.
